(19) United States
(12) Patent Application Publication
(10) Pub. No.: US 2015/0291245 A1
(43) Pub. Date: Oct. 15, 2015

(54) Leaning Tricycle

(71) Applicants: Richard Anton Thrush, Jersey City, NJ (US); Steven Donald Thrush, Jersey City, NJ (US); Richard Gilbert Thrush, Grand Rapids, MI (US)

(72) Inventors: Richard Anton Thrush, Jersey City, NJ (US); Steven Donald Thrush, Jersey City, NJ (US); Richard Gilbert Thrush, Grand Rapids, MI (US)

(21) Appl. No.: 14/251,608

(22) Filed: Apr. 13, 2014

(51) Int. Cl. B62K 21/00; B62K 5/02

(52) U.S. Cl. CPC B62K 21/005; B62K 5/02

(57) ABSTRACT

The present invention was conceived based on observations of children learning to balance a bicycle and the turning versus leaning of the bicycle. The result is a tricycle which leans when it is steered and provides the additional feature of limiting the lean so the tricycle will not fall over. The fact that the lean is controlled by the rider based on steering input and the lean is limited inspires confidence in the rider to facilitate learning to balance as in a bicycle. A key to this rendition was to make it very similar to a conventional tricycle with the simplest implementation practical. In addition, the features described make this an excellent tool for relearning balance after a medical condition.

### BACKGROUND OF THE INVENTION

1. Field of the Invention

The present invention relates to tricycles and particularly tricycles that lean based on amount of steering input to facilitate a riding experience that is similar to a bicycle,

2. Description of Prior

The present invention is an improvement on the concepts of prior art in that it is much simpler, limits the lean, and retains the appearance of a conventional tricycle. Following is a list of prior art patents and the short comings related to this submittal.

7976046 B2 Rathsack July 2011: In this patent, the steering does not drive the lean of the body. This patent has no articulated frame with articulation at an angle to vertical.

8128109 B2 Chen March 2012: In this patent the tricycle is not driven by foot power. The body and rider do not lean as a function of handlebar movement.

7798513 B1 Salvent September 2010: In this patent, the body and rider do not lean as a function of handlebar movement. The body is not constrained from falling over.

7798510 B1 Comstock September 2010: In this patent, the body and rider do not lean. The front wheel is not cambered as a function of handlebar move as a function of handlebar movement.

7540517 B2 Wernli June 2009: In this patent, the body and rider do not lean as a function of handlebar movement. In this patent the tricycle is not driven by foot power via wheel.

7188853 B2 Yen March 2007: In this patent, the body and rider do not lean. The front wheel is not cambered as a function of handlebar movement.

6499751 B1 Beleski, Jr. December 2002: In this patent, no lean of the body is claimed, discussed, or emphasized. There is no claim discussing the limit of lean or steering angle.

6402174 B1 Maurer June 2002: In this patent, the body and rider do not lean as a function of handlebar movement. The front wheel is not cambered as a function of handlebar movement

6220612 B1 Beleski, Jr. April 2001: In this patent, the body and rider do not lean as a function of handlebar movement. In this patent the tricycle is not driven by foot power via wheel.

6062581 B1 Stiltes May 2002: In this patent, the body and rider do not lean as a function of handlebar movement. The front wheel is not cambered as a function of handlebar movement.

5941548 B1 Owsen August 1999: In this patent, the body and rider do not lean as a function of handlebar movement. The front wheel is not cambered as a function of handlebar movement.

5730453 Owsen March 1998: In this patent, the body and rider do not lean as a function of handlebar movement. The front wheel is not cambered as a function of handlebar movement.

5240267 Owsen August 1993: In this patent, the body and rider do not lean as a function of handlebar movement. The front wheel is not cambered as a function of handlebar movement.

5568935 Mason Oct 1996: In this patent, the body and rider do not lean as a function of handlebar movement. The front wheel is not cambered as a function of handlebar movement.

5501478 Doan March 1996: In this patent, the body and rider do not lean as a function of handlebar movement. The front wheel is not cambered as a function of handlebar movement.

3504934 Wallis June 1966: In this patent, the body and rider do not lean as a function of handlebar movement. The front wheel is not cambered as a function of handlebar movement.

None of these patents show a vehicle with one wheel at the front and two at the back where the steering is connected with the leaning/cambering of the body/frame/rider.

### SUMMARY

In accordance with the invention a more exciting and instructional riding experience is created by restricting the rider and main body of the tricycle to lean to the inside of a turn as the steering mechanism is rotated.

A primary object of the present invention is to provide a vehicle that creates a riding experience that is similar to a bicycle by leaning toward the inside of a turn while limiting the lean to prevent the rider from falling over.

Another objective is to provide a means to learn and improve balance in in the case of a first time rider or person rehabilitating from a medical condition.

Another objective is to provide a very simple implementation of the tricycle and limited moving parts, with the steering controlled leaning capability.

Another objective is to provide a tricycle with the steering controlled leaning capability that has rear wheel steering as well, for tighter turns

Another objective is to provide a tricycle with the steering controlled leaning capability that has a broad base for stability

Another objective is to provide a tricycle with the steering controlled leaning capability that a rider or passenger can stand on the rear wheel tread like a conventional tricycle

Another objective is to provide a tricycle with the steering controlled leaning capability that visually looks like a conventional tricycle for improved acceptance

Other objectives and advantages will become apparent in the following specification when considered in light of the attached drawings.

### BRIEF DESCRIPTION OF THE DRAWINGS

In the drawings, which form a part of this specification:

FIG. 1 is a front perspective view of the tricycle with the front steering assembly centered;

FIG. 2 is a rear perspective view of the tricycle with the front steering assembly centered;

FIG. 3 is a top perspective view of the tricycle with the front steering assembly rotated to the right to turn the tricycle and the main body leaning to the right. It shows the motion of the front steering assembly, the resulting movement of the connection, and the resulting turn of the rear wheel tread body assembly and lean of the main body;

FIG. 4 is a right side elevation of the tricycle with front steering assembly centered; showing the inclination of the steering assembly pivot axis in relation to the main body and a representative inclination of the pivot axis between the main body and rear wheel tread body assembly;

FIG. 5 is a rear elevation with the front steering assembly centered;

FIG. 6 is a rear elevation with the front steering assembly rotated to the right and the main body leaning to the right. It shows the motion of the front steering assembly, the resulting movement of the connection, and the resulting turn of the rear wheel tread body assembly and lean of the main body;

FIG. 7 is a top rear perspective showing front steering assembly pivot location within the main body.

FIG. 8 is a perspective showing the front steering assembly pivot showing the range of motion with a dotted line.

FIG. 9 is a perspective showing the front steering assembly pivot showing a cross section line

FIG. 10 is a cross section of the front steering assembly pivot showing the clockwise-most limited steering.

### DETAILED DESCRIPTION

The following discussion describes in detail one embodiment of the invention (and several variations of that embodiment). This discussion should not be construed, however, as limiting the invention to those particular embodiments; practitioners skilled in the art will recognize numerous other embodiments as well. For a definition of the complete scope of the invention, the reader is directed to the appended claims.

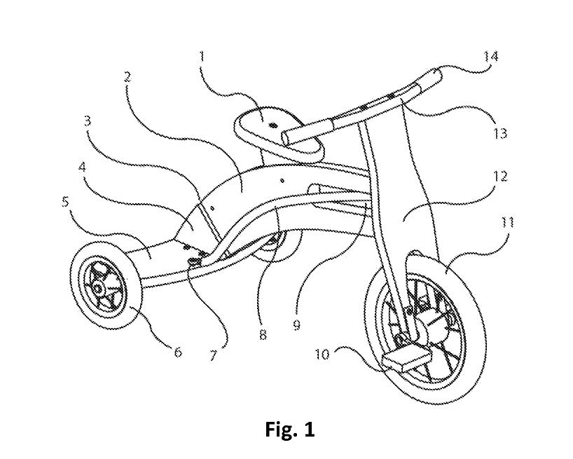

FIG. 1 is a front perspective view of the tricycle with the front wheel steering assembly centered. Shown is the present embodiment of the invention in complete assembly which consists of:
1. Seat
2. Main body
3. Rear pivot
4. Vertical bracket
5. Rear wheel tread body assembly
6. Rear wheels
7. Connection point
8. Connection
9. Main body pass through
10. Pedal assembly
11. Front wheel
12. Front wheel steering assembly
13. Handle bars
14. Hand grips

As shown in FIG. 1, the main body 2 is attached to the vertical bracket 4 via the rear pivot 3. The vertical bracket is rigidly attached perpendicular to the rear wheel tread body assembly 5. Rear wheels 6 rotate on an axle rigidly attached to the bottom of the rear wheel tread body assembly 5. The rear of the connection 8 is pivotally attached to the rear wheel tread body assembly at connection point 7. The connection 8 passes through the main body pass through 9 to the opposite side.

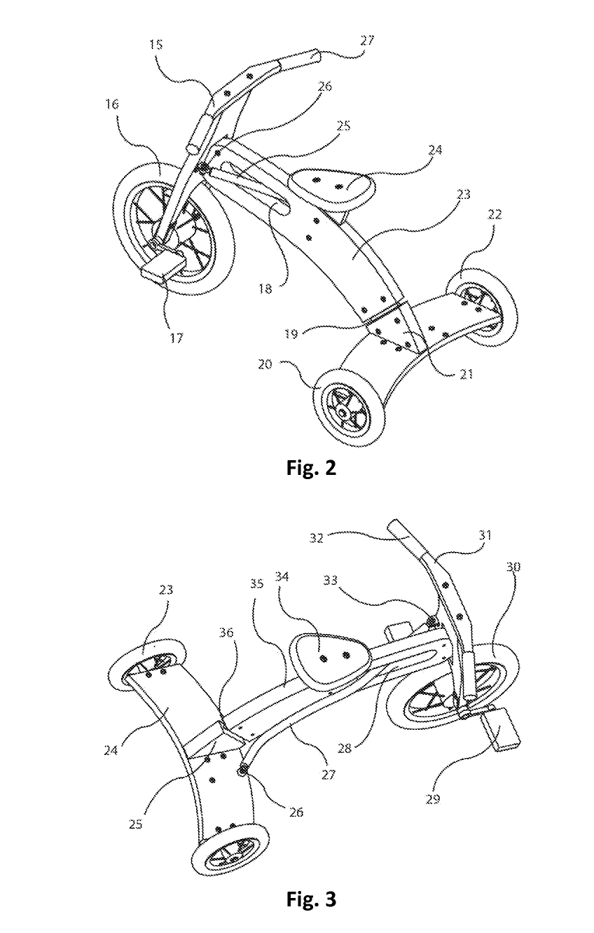

As shown in FIG. 2, connection 8 has a front pivotal connection 15 to the front wheel steering assembly 12. Continuing with FIG. 1, pedal assembly 10 is mounted to the front wheel steering assembly 12 such that it can rotate and the pedals used to power movement of the trike by rotating the front wheel 11. Handle bars 13 are attached to the top of the front wheel steering assembly 12 to facilitate steering the front wheel 11. Hand grips 14 are added to indicate the hand position to the rider. The front wheel steering assembly 12 is attached to the main body 2 through a pivot connection 16 most clearly shown in FIG. 2.

FIG. 3 is a top perspective view of the tricycle with the front wheel steering assembly rotated to the right to turn the tricycle and the main body leaning to the right. It shows the motion of the front wheel steering assembly, the resulting movement of the connection, and the resulting turn of the rear wheel tread body assembly and lean of the main body. In this figure the rider has pushed on the hand grip 14 connected to the handle bars 13, which are connected to the front wheel steering assembly 12. The front wheel steering assembly 12 is connected to the front wheel 11, which has pivoted in relation to the main body 2 and rear wheels 6. This action by the rider will turn the tricycle to the right front wheel steering angle 17 as it is propelled forward. The more the handlebars 13 are turned, the tighter the tricycle will turn and the more the main body 2 will lean. There is a dotted line showing the position of the centerline of the axis of the front wheel 11 before turning. The handlebars 13 are turned to the limit in this view. The motion of the handlebars can be limited by the front wheel steering assembly 12 at front pivot connection 16. An additional result of the handlebars 13 being turned is the front wheel steering assembly 12 will pull on the connection 8 via front pivotal connection point 15. The connection 8 will pull on the connection point 7 which will pull on the rear wheel tread body assembly 5. This will result in the rear wheel tread body assembly 5 turning for rear wheel steering shown as rear wheel centerline axis angle 18. There is a dotted line showing the position of the centerline of the axis of the rear wheels 6 before turning. The rear wheel steering decreases the turn radius. This action by the rider will result in the main body 2 pivoting via rear-pivot 3 in relation to the rear wheel tread body assembly 5 as well as the plane of the ground 19. An additional result will be the main body 2, seat 1, and rider leaning to the right in relation to the vertical axis 20. The more the handlebars 13 are turned the more the main body 2 will lean in relation to the vertical axis 20 in the side to side direction. The motion of the handlebars 13 can be limited by the front wheel steering assembly pivot 24 which also limits the leaning of the main body 2 in relation to the vertical axis 20 in the side to side direction. When the front wheel steering assembly 12 is turned to the counterclockwise (opposite) direction, the motion of all the parts act the same in mirror image.

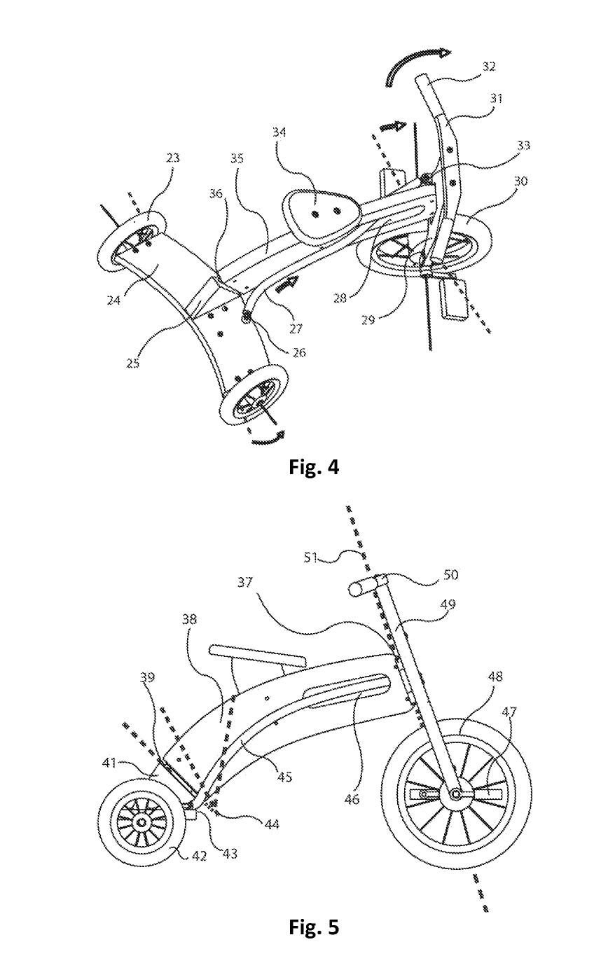

FIG. 4 is a right side elevation of the tricycle with front wheel steering assembly 12 centered. The plane of the ground is shown with line 19. The centerline of the front wheel steering assembly pivot 20 is illustrated by a dashed line. This dashed line shows the axis of movement of front wheel steering assembly 12 in relation to the main body 2. The possible centerlines of the rear pivot 3 are illustrated by several dashed lines. The centerline for the rear pivot 3 is shown at an angle 21 to the plane of the ground 19. The angle 21 results in both lean of the main body 2 and rear wheel steering with the rear wheel tread body assembly 5 when the handle bars 13 are turned. The dashed lines near rear pivot 3 show the possible axes of movement of the main body 2 in relation to the rear wheel tread body assembly 5, rear wheels 6 and the plane of the ground 19. These changes in possible axes will result in different relationships between magnitude of leaning and rear wheel steering depending on front wheel steering input.

FIG. 5 is a rear elevation with the front wheel steering assembly 12 shown centered; the front wheel steering assembly pivot centerline 20 are shown centered vertically from the rear elevation. The main body 2 is also centered vertically in relation to the plane of the ground 19. The rear wheels 6 are shown on the same fixed axis 22 that does not change as the main body 2 is in motion.

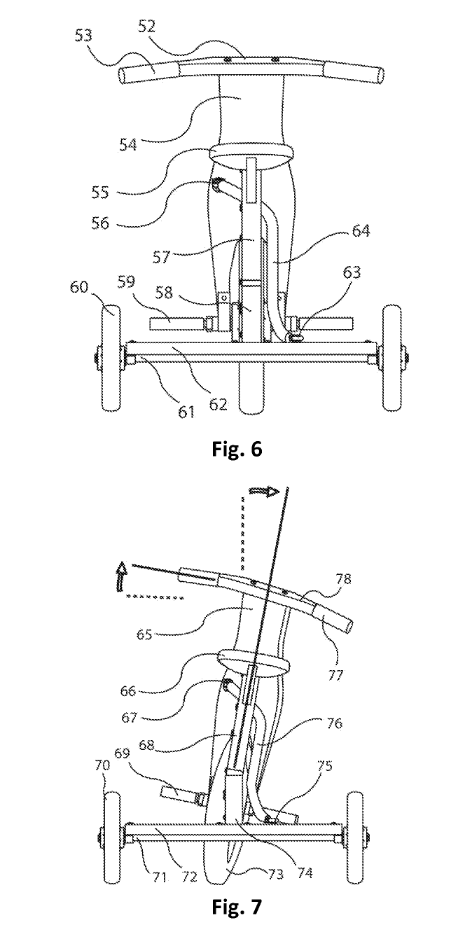

FIG. 6 is a rear elevation with the front wheel steering assembly 12 rotated to the right and the main body 2 leaning to the right. It shows the motion of the handlebars 13, the resulting movement of the connection 8, and the resulting turn of the rear wheel tread body assembly 5, and lean of the main body 2. The handlebars 13 are shown rotated to the right by the rider. The handlebars 13 are also rotating the front wheel steering assembly 12. The centered position of the handlebars 13 is shown with a dashed line as well as the turned position of the handlebars 13 shown with a solid line. The handle bar turn angle 23 shows the difference between the turned versus centered position. The front wheel steering assembly 12 is pulling on the connection 8 via front pivotal connection point 15 which pulls on the connection point 7 which pulls the main body 2 to lean to the right also cambering the front wheel 11 in the same action. The vertical centerline of the main body 2 is shown leaning in relation to a dashed line showing the vertical axis 20. When the front wheel steering assembly 12 is turned to the counterclockwise direction, the motion of all the parts will act the same in mirror image.

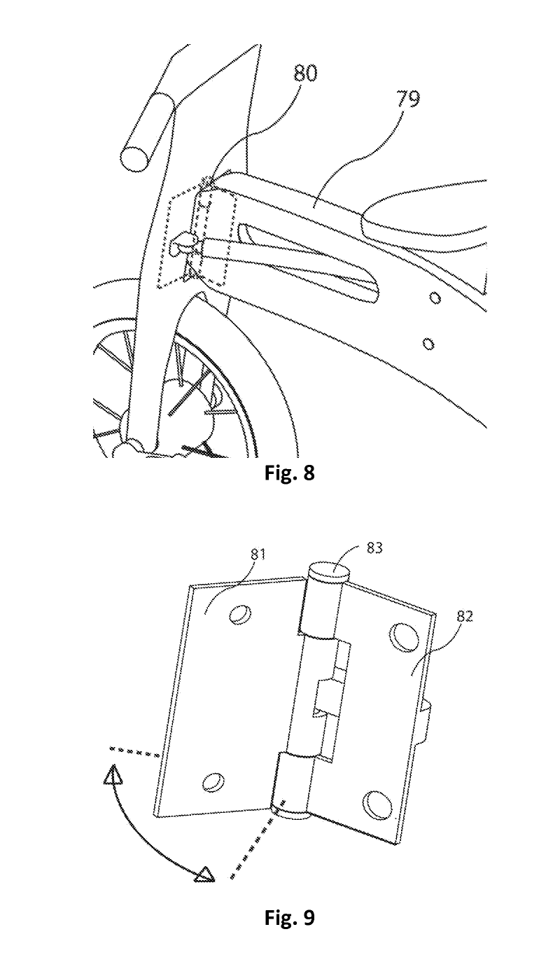

FIG. 8 is a perspective showing the steering assembly pivot 24. The steering assembly pivot attachment arm 25 is connected to the steering assembly pivot main body attachment arm 26 via steering assembly pivot axis pin 27. The steering assembly pivot attachment arm 25 may rotate in relation to the steering assembly pivot main body attachment arm 26. The range of motion is shown with dotted lines. The motion is limited with mechanical stops.

FIG. 9 is a perspective showing the steering assembly pivot 24 showing a cross section line 28.

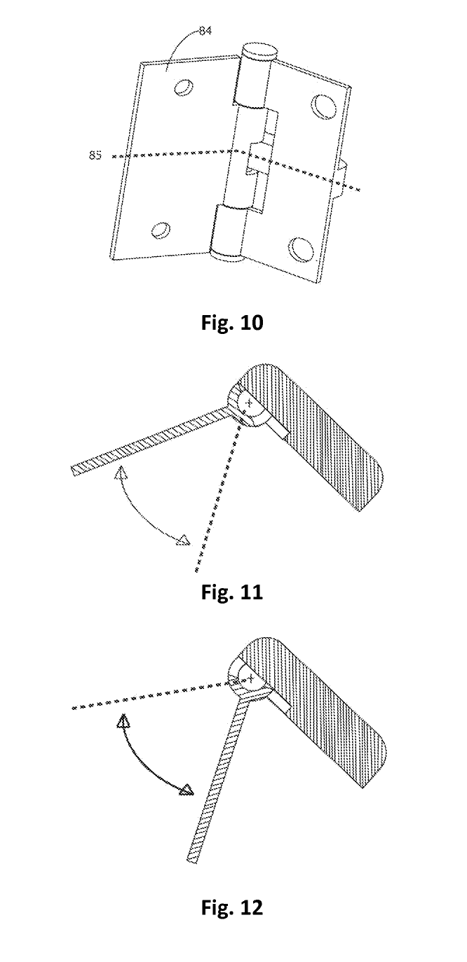

FIG. 10 is a cross section of the front wheel steering assembly pivot showing the clockwise-most mechanical stop. The steering assembly pivot attachment arm 25 may not rotate clockwise any further. Conversely, the steering assembly pivot attachment arm 25 has limited rotation counter clockwise due to the opposite mechanical stop. The limited range of motion is shown with dotted lines.

What is claimed is:

1. A three wheel vehicle comprising:
a front wheel with steering means pivotally mounted to the main body;
a rear wheel tread body assembly with two wheels in the rear centered on the same axis; and
a rear wheel tread body assembly attached to the main body through a pivot joint with an axis that is angled with respect to the plane of the ground.

2. The three wheel vehicle as defined in claim 1 wherein the rear wheels do not camber and the rear wheel tread body assembly stays parallel to the plane of the ground as the steering mechanism is turned and main body leans with respect to the vertical axis.

3. The three wheel vehicle from claim 1 wherein the lean of the main body in relationship to the vertical axis is controlled by steering input via communication between front wheel steering assembly and rear wheel tread body assembly through a single rigid link with pivotal connections.

4. The three wheel vehicle as defined in claim 1 wherein forces due to vehicle geometry while in motion encourage the front wheel steering to straight forward position and lean of the main body to the vertical axis.

5. The three wheel vehicle as defined in claim 1 wherein the steering angle and lean of the main body can be limited by mechanical stops at the steering pivot or pivot joint between the main body and rear wheel tread body assembly.

6. The three wheel vehicle as defined in claim 1 wherein the main body to rear wheel tread body assembly pivot is at a fixed angle such that as the front steering mechanism is turned the rear wheels steer in addition to the main body leaning with respect to the vertical axis.
